(19) United States
(12) Patent Application Publication
(10) Pub. No.: US 2008/0013917 A1
(43) Pub. Date: Jan. 17, 2008

(54) Information intermediation system

(75) Inventors: Annika Hegardt, Billdal (SE); Robert Hellman, Onsala (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Time ToMarket Viewlt Sweden AB, Billdal (SE)

(21) Appl. No.: 11/823,303

(22) Filed: Jun. 26, 2007

Related U.S. Application Data
(63) Continuation-in-part of application No. PCT/SE05/01614, filed on Oct. 26, 2005.

(51) Int. Cl. H04N 5/91

(52) U.S. Cl. 386/66; 386/E05.001

(57) ABSTRACT

The present invention relates to a system and method of synchronizing a first and a second motion pictures from a first and a second source in a digital environment by bringing together said motion pictures based on a time line, synchronising said motion pictures by relating said second motion picture to said first motion picture using said time line and the content of said first motion picture, and generating a third motion picture comprising said synchronized first and second motion pictures.

### CROSS-REFERENCE TO RELATED APPLICATIONS

This application is a continuation of International Application No. PCT/SE2005/001614, filed Oct. 26, 2005, the disclosure of which is incorporated by reference herein.

### TECHNICAL FIELD

The present invention relates to a system and method for arranging and intermediating flows of information, preferably provided as motion pictures. According to one aspect, the invention is a part of an application relating to an information intermediation system, preferably for educational and media production purposes.

### BACKGROUND OF THE INVENTION

The ever increasing amount of computer based applications requires new ways of training, information and communication and thus new ways of information intermediation. There is also a need for an information intermediation system in today's business climate when it is required to reach customers with information of products.

The new information highways (broadband transmissions, cable TV or satellite) allow long-distance entertainment, information and communication lecturing. Using film broadcasting over Internet, for example, allows a tutor in a simple manner to transmit information to a number of audiences.

One problem is to provide the audiences with different types of information in a synchronised manner. The information can be a motion picture of a tutor and the subject the tutor is lecturing.

New interactive methods have been presented in which motion images and images of applications can be synchronized.

In WO 03091890, for example, a method, computer program product and system for combining multimedia inputs into an indexed and searchable output are provided. The invention allows a user to review an entire (oral) presentation containing several multimedia components e.g., audio, video, slides, charts, electronic whiteboard, online Web tour, online software demonstration and the like using only a Web browser, rather than a TV and VCR as is conventionally done. These various multimedia sources are then synchronized to produce an indexed, searchable, and viewable run-time output combining all of the inputted information. The invention allows searching for a particular topic and an immediate review all the slides and the accompanying video that mentioned that topic, thus enhancing the user's comprehension of the presentation.

### SUMMARY OF THE INVENTION

According to the invention, an XML meta-file is generated for registering an event, which represents the captured, time stamped event. Complementary information is added to the event and a link is generated. A time line is generated, integrated and synchronizes the multimedia information. The result is a video of for example a lecturer together with e.g. Power Point presentation. The video may then be viewed using a web browser or stored on a compact disk. A video is synchronized using time stamp events in one or several programs.

The present invention aims to provide a novel method and system for synchronizing a media stream for generating a movie, comprising set of motion image based data structures, into a substantially immediately streamable media and allows production workers to produce information, e.g. education material by a tutor with one or several related and synchronized movies for different information types on a communication platform, e.g. using a web browser.

The invention allows production workers to produce education material or information by a tutor with one or several synchronized movies for all types of education situations on a communication platform using a web browser.

Thus the invention relates to a method of synchronizing a first and a second motion picture from a first and a second source in a digital environment, the method comprising: bringing together said motion pictures based on a time line, synchronising said motion pictures by relating said second motion picture to said first motion picture using said time line and the content of said first motion picture, and generating a third motion picture comprising said synchronized first and second motion pictures. Preferably, the first motion picture comprises a video sequence of a person giving a presentation. The second motion picture comprises a recorded image sequence of a subject related to said person's presentation.

The invention also relates to a system for synchronizing a first and a second motion picture, said first motion picture being provided from a first source and said second motion source from a second source, the system comprising: a unit for receiving said motion pictures, a unit for making a time line having time units. The system comprises: an arrangement for bringing together said motion pictures based on said time line, an arrangement for synchronising said motion pictures by relating said second motion picture to said first motion picture using said time line and the content of said first motion picture, and an arrangement for generating a third motion picture comprising said synchronized first and second motion pictures. Preferably, the system comprises means for receiving several types of motion pictures.

The first motion picture comprises video sequences of a person and the second motion picture comprises video sequences recorded from a computer application.

The system may comprise a server for storing said third motion picture, which server can be connected in a network for access by means of a client computer.

The invention further relates to an education system comprising a system as mentioned earlier and allowing access of one or several pupils for running a education application in which said first motion picture comprises a tutor video and said second motion picture image of an application presented by said tutor.

The invention also relates to a processor operable to carry out a computer program for synchronizing a first and a second motion picture from a first and a second source in a digital environment. The computer program comprising instruction sets for: Initiating said motion pictures with same start on a time line, providing sequences of said first motion picture with unique codes, dividing said second motion picture into sections, providing said sections with links and linking each of said sections with time codes of said sequences of said first motion picture, and generating a third motion picture comprising said synchronized first and second motion pictures containing said links.

The invention also relates to a propagated signal encoded with instructions for synchronizing a first and a second motion picture from a first and a second source in a digital environment. The instruction sets comprise instructions for: Initiating said motion pictures with same start on a time line, providing sequences of said first motion picture with unique codes, dividing said second motion picture into sections, providing said sections with links and linking each of said sections with time codes of said sequences of said first motion picture, and generating a third motion picture comprising said synchronized first and second motion pictures containing said links.

The invention also relates to a propagated signal encoded with a media stream, the media stream comprising an information motion picture and an information subject motion picture. The information motion picture and information subject motion pictures are produced according to a previously described method.

The invention also relates to an article of manufacture readable by a computer comprising a media stream, the media stream being encoded with an information motion picture and an information subject motion picture. The information motion picture and information subject motion pictures are produced according to a previously described method.

### BRIEF DESCRIPTION OF THE DRAWINGS

In the following, the invention will be further described in a non-limiting way with reference to the accompanying drawings in which:

FIG. 1 is a block diagram illustrating different steps of an application employing the invention,

FIG. 2 illustrates a block diagram of the invention according to one exemplary embodiment,

FIG. 3 is a schematic illustration of a display image of an application using the invention,

FIG. 4 is a schematic illustration of a display image of a second application using the invention,

FIG. 5 illustrates a timing diagram for the invention, and

FIG. 6 is a block diagram illustrating an example of an arrangement for carrying out the invention.

### DESCRIPTION OF PREFERRED EMBODIMENTS

Basically, the invention is a media stream synchronizer for synchronizing related movies, wherein a set of motion picture based data structures is converted into an immediately streamable media and allows production workers to produce education or information by a tutor with one or several related and synchronized movies for all types of education and information situations on a communication platform.

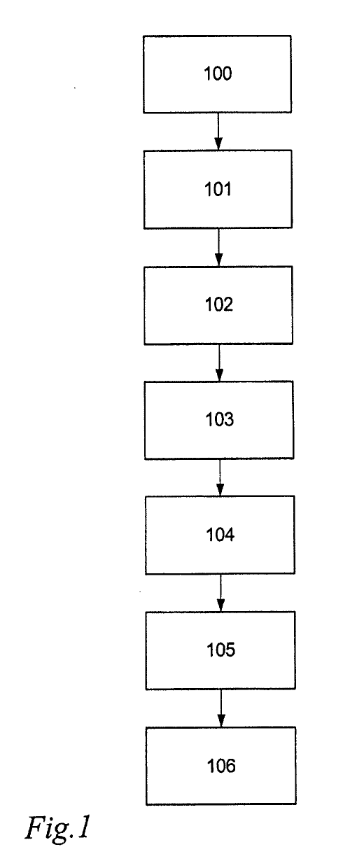

FIG. 1 is a block diagram illustrating the steps of the invention based on one exemplary embodiment. In this case the description is based on an educational system for teaching out how to use a computer program, such as Excel.

The steps comprise:
100 Making a movie of a tutor (informer)
101 Screen recording of the subject matter
102 Converting the screen recording to a motion picture
103 Making one or several motion pictures or movies of the information subject related to the movie of a tutor
104 Synchronizing the movie and motion pictures using a time line
105 Producing one movie of the synchronised result
106 Storing the result as a movie

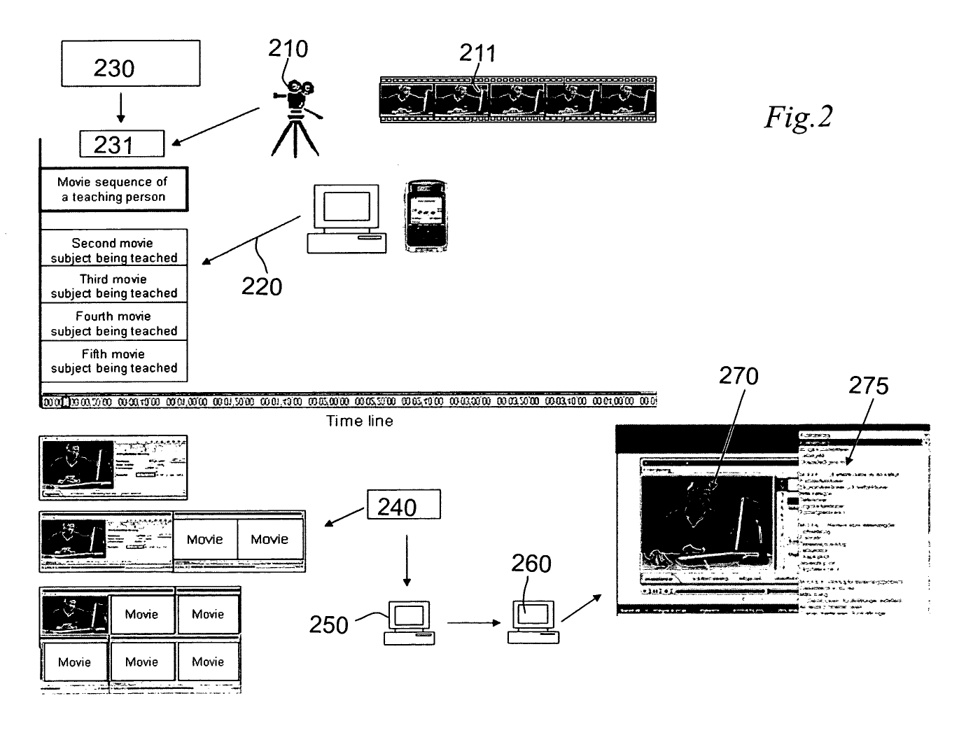

The block diagram of FIG. 2 illustrates above steps in more detail. Using a camera 210 a movie sequence 211 of a tutor is produced. Simultaneously or in another occasion a screen recorder is used to record 220 the subject of the information material. The subject may for example be a computer application or use of a device such as a cell phone or a cell phone application. Preferably, several subjects can be recorded.

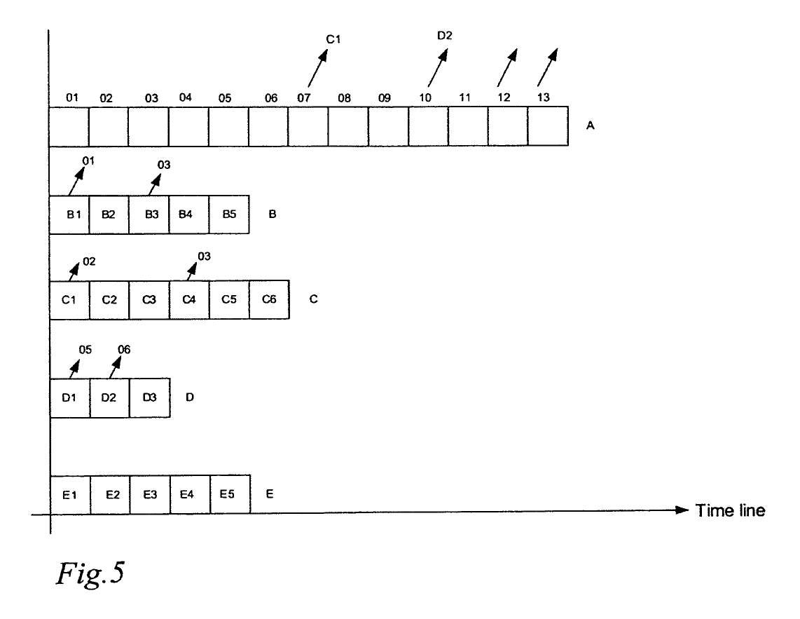

The movie sequence of the tutor is imported 230 to an arrangement 231, which converts the movie to a chosen fps (frames per second). In this case, while playing the first imported movie sequence of the tutor the screen recorder records the second movie sequence, i.e. the subject being teached/informed about related to the first movie of the tutor. The two movies are then synchronized with the same frames per second based on a time line the image converter is in several levels. This is illustrated in FIG. 5, in which A represents the tutor movie and B-E cuts subject movies. The tutor movie is divided into sequences and provided with time codes 01-13, and the movie of the subject lectured is divided into cuts B-E. Each cut comprises frames (B1-B5, C1-C6, D1-D3, E1-E5) and each section and/or frame is linked to one or several of time codes of the tutor movie, here illustrated by arrows pointing at time codes. Of course, in reality the number of cuts and frames are much more. Initially, all movies are synchronized with respect to a time line, i.e. they are initiated at same time. The resulting movie is then converted to a new motion picture, in form of an interactive output, which may be compressed media data. Also the sections of the tutor film sequences can be linked to the frames of different movies B-E. For example C1 (frame 1 in movie C) is linked to time code 02.

The result 240 is provided to a server 250 comprising a storage device for storing the movie. One or several client computers 260 may then access the motion picture files. The result on the screen of the client computer will be a motion picture with at least two fields or windows running simultaneously and synchronised. One field 270 shows the tutor and the second one 275 the subject discussed.

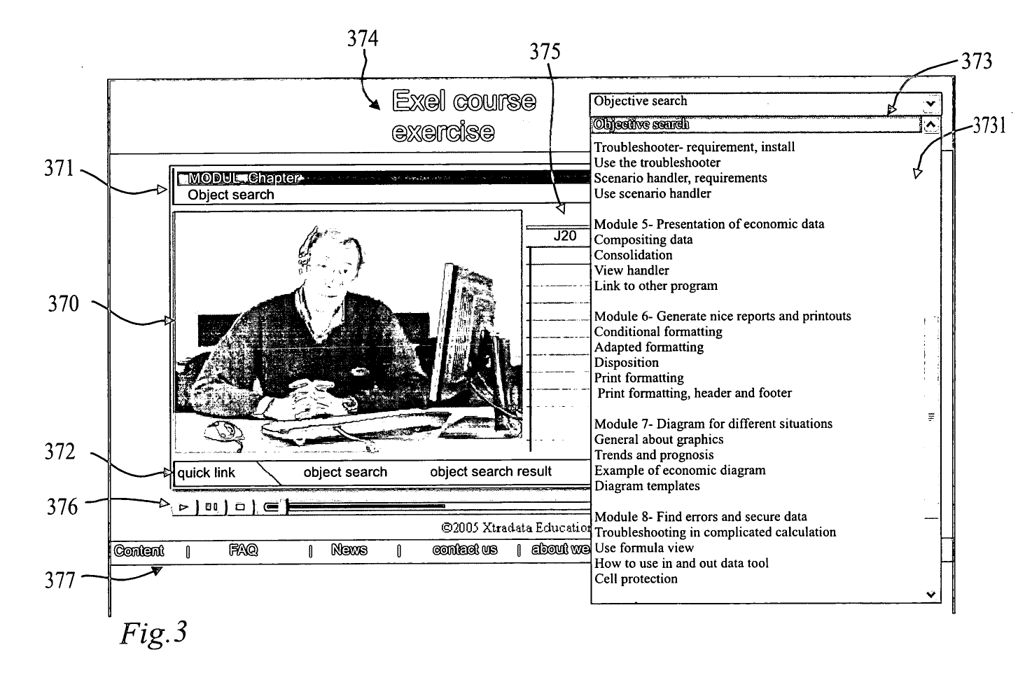

FIG. 3 illustrates the displayed fields. The displayed field comprises, as mentioned earlier, the movie field 370 of the tutor, a movie 375 field comprising the subject discussed (Excel sheet in this case), a title field 371, menus 372, 373, 374 and control field 376.

Menus 372 are for choosing other functions related to the subject matter and links to the parts of the subject matter discussed related to the sequence illustrated. It is also possible to provide the user with the menu 373 for choosing different types of subject matter/courses, and menu 374 for choosing exercises. Clearly, other menus and links may also occur.

The control field 376 is used for playing, rewinding and playing forward the movie and comprises control keys 3761, 3762, 3763, 3764, 3765 and bar 3766.

Other fields 377 allowing interaction with a service provider which for example enables asking questions and receiving answers may also be provided.

Using menus 373, it is possible to initiate different sections or “chapters” 3731 in the lecture film. Thus, each menu subject is provided with a link to a time code on the tutor movie, which in turn points at a frame in the subject movies as described earlier.

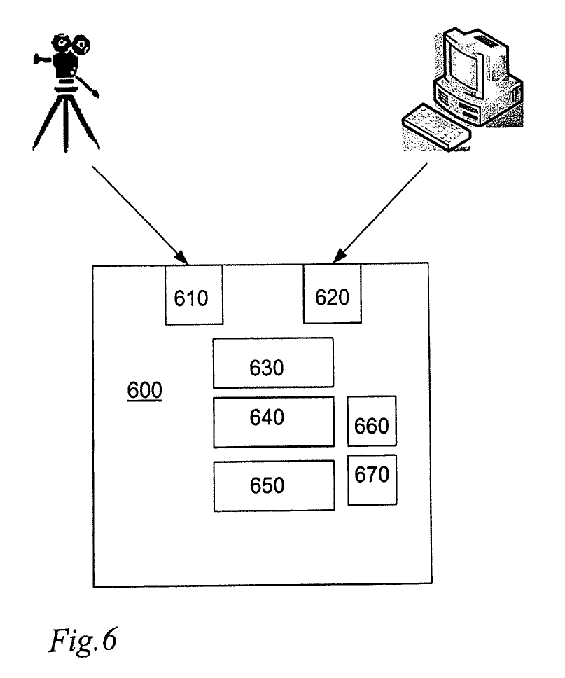

The synchronization and linking of the films may be carried out manually or automatically. A preferred embodiment of an arrangement for carrying out the invention is illustrated in FIG. 6. The arrangement, preferably a computer 600 comprises inputs 610 and 620 for receiving media streams, i.e. film from the camera and the captured film from the tutor's computer. Of course, depending on the application signals from several computers and cameras can be received. The arrangement further comprises storage unit 630, a converter 640, a linking arrangement 650, a memory unit 660, micro-processor 670, and inputs/outputs 680 for interaction with a user.

The storage unit 630 is arranged for storing the incoming movies. The converter 640 converts films into digital form if they are in analogue form. The memory unit 660 contains instruction set for controlling the arrangement. The micro-processor 670 controls the functions of the arrangement based on the instructions in the memory unit. The inputs/outputs 680 comprise connections for, e.g. keyboard, mouse, display, etc.

The linking arrangement 650, which may be implemented in hardware or software, synchronises the films which may be stored on the storage unit 630, and based on the instructions from the user links the films and sets pointers between the different frames and sections. The linking arrangement works with time codes of the films; based on the marked frames films are linked.

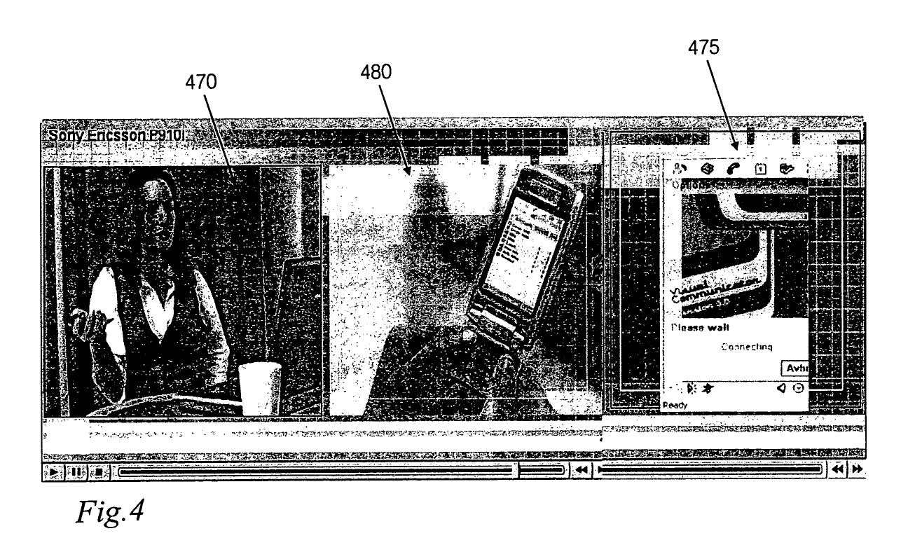

As mentioned earlier, the invention may be used for different types of applications and not only educations. FIG. 4 illustrates an application for informing about a cell phone application. In this case, three movie fields 470, 475 and 480 are used. The middle movie field 480 is used for illustrating how to use the cell phone, e.g. which keys should be used etc., while field 470 shows the tutor and field 475 the application appearance.

Other applications for the invention are:
Product introductions, where the products are presented using several films over the Internet.
Interactive manuals for different products,
Information, informing about events,
Tourist information,
Etc.

In a variant of the invention, the steps 100 through 106 are executed in real or near real time, allowing a user to monitor several point of interest in real or near real time.

The mixing of movies may be done according to different templates whereby the individual movies obtained during step 100-103 are mixed accordingly. For example, a large image may be used for a depiction of a computer program with many details and a smaller image may be used for a tutor explaining the computer program. If a single template is used throughout the presentation the mixing of pictures is said to be static.

In contrast to applying a static template, one may use a set of templates during the course of mixing movie sourced in step 104-106 whereby the template used for mixing is changed at least one time. This may be useful when important issues are explained in detail by a tutor or when the focus of a presentation changes substantially.

In a variant of the invention, the user has access to a plurality of mixing templates from which she may, at any time, select the one she considers as most appropriate. In a variant of the invention, a plurality of mixing templates is generated in advance in steps 100-103 (FIG. 1) using the same movies but with different mixing templates. In one variant of the invention, a current movie stream is interrupted upon user selection of a new mixing template and the new movie stream using the new template is immediately sent to the user instead. In yet another variant of the invention, different movie template streams may be transmitted to the end user simultaneously, allowing seamless switch-over between templates.

Associated to the graphical images of the plurality of movies that are to be combined in steps 104-106 may also be audio streams. Each of the audio streams may be either uncorrelated, semi-correlated or correlated to each other depending on, for example, the spatial correlation between the cameras used to obtain the initial movie recordings. Recordings made at substantially disjunct locations may for example have uncorrelated audio; where as recordings made with cameras with a relatively short distance between themselves may have correlated audio streams. In a variant of the present invention, the audio streams may now be mixed such that their individual strength 104-106 is predetermined once. In other words, the resulting audio stream rendered for the combination of movies A may be expressed as A=ΣV(n)×A(n), 0<n<N, where N are the number of movies combined, A(n) are the individual audio streams and V(n) the volume for each audio stream 0≦V(n)≦1.

In another variant of the invention, the mixing of audio streams may be varied dynamically during the course of mixing, such that the resulting stream A is a concatenation of different mixing settings applied to the audio streams whereby the different mixing settings are applied at different times. For example, if there are M different settings used during the mixing of movies the resulting audio stream A is the concatenation of the different mixing settings applied to the audio streams such that
A=[ΣV(1,n)×A(n), . . . , A=ΣV(M, n)×A(n)], 0<n<N, 0<n<N
where V(1,n) is the first set of volumes for the audio streams A(1) . . . A(N) and V(M, n) is the last set of volumes. For example, the volume settings are varied over time such that the individual movie that the producer deems the most interesting at any time will be assigned the highest mixing volume V at that time.

In another embodiment of the invention, selection of mixing templates and mixing of audio streams are correlated. For example, if a new mixing template is selected where by a certain movie is enlarged, the audio mixing volume from that particular enlarged movie may be increased simultaneously. At this time, other audio mixing volumes may be reduced and/or changed. In this way, audio and video experience will be intuitive coherent to spectators.

In yet another embodiment of the invention, the making one or several motion pictures or movies of the information subject related to the movie in step 103 are not filmed via separate cameras. Instead, the movie or movies related to information subjects are extracted from the initial movie made in step 100-102. For example, by extracting portions of the tutor movie made in step 100-102 whereby said portions are enlarged, filtered or are otherwise digitally processed (Including but not limited to applying colour filtering, digital image enhancements, blurring or refocusing). An example would be to show a tutor showing a gadget whereby an area including the gadget is extracted and enlarged. Both the movies are then subsequently merged as described in 104-106 producing a resulting movie where both the tutor and the gadget can be seen with sufficient quality and where the tutor images are not unnecessary bandwidth consuming which would be the case of both the tutor and the gadget were to be transmitted as originally filmed.

The invention is not limited to the shown embodiments but can be varied in a number of ways without departing from the scope of the appended claims and the arrangement and the method can be implemented in various ways depending on application, functional units, needs and requirements etc.

1. A method of synchronizing a first and a second motion picture from a first and a second source in a digital environment, said method comprising:
initiating said first and second motion pictures at a same start time on a time line;
arranging sequences of said first motion picture with unique codes;
dividing said second motion picture into sections;
providing said sections with links and linking each of said sections with time codes of said sequences of said first motion picture; and
generating a third motion picture comprising said synchronized first and second motion pictures containing said links.

2. The method of claim 1, wherein said first motion picture comprises a video sequence of a person giving a presentation.

3. The method of claim 2, wherein said second motion picture comprises a recorded image sequence of a subject related to said persons presentation.

4. The method of claim 1, wherein a user has access to a plurality of mixing templates from which the user selects the one considered as most appropriate.

5. The method of claim 1, wherein a plurality of mixing templates is generated in advance using the same motion picture but with different mixing templates.

6. The method of claim 1, wherein a current motion picture stream is interrupted upon user selection of a new mixing template, and a new motion picture stream using the new template is immediately sent to the user instead.

7. The method of claim 1, wherein different motion picture template streams are transmitted to an end user simultaneously to allow seamless switch-over between templates.

8. The method of claim 1, wherein associated graphical images of a plurality of said motion pictures that are to be combined are audio streams, and each of said audio streams is either uncorrelated, semi-correlated or correlated to each other depending on a spatial correlation between image recording devices used to obtain an initial motion picture recordings.

9. The method of claim 8, wherein the audio streams are mixed such that their individual strength is predetermined once, and a resulting audio stream rendered for a combination of motion pictures, A, is expressed as
A=ΣV(n)×A(n), 0<n<N,
where N are the number of motion pictures combined, A(n) are the individual audio streams, and V(n) are the volume for each audio stream 0≦V(n)≦1.

10. The method of claim 8, wherein the mixing of audio streams is varied dynamically during the course of the mixing, such that the resulting stream A is a concatenation of different mixing settings applied to the audio streams whereby the different mixing settings are applied at different times.

11. The method of claim 10, wherein for M different settings used during the mixing of motion pictures the resulting audio stream A is the concatenation of the different mixing settings applied to the audio streams such that
A=[ΣV(1,n)×A(n), . . . , A=ΣV(M, n)×A(n)], 0<n<N, 0<n<N
where V(1,n) is a first set of volumes for the audio streams A(1) . . . A(N), and V(M, n) is the last set of volumes.

12. The method of claim 11, wherein volume settings are varied over time such that the individual motion picture that the producer deems the most interesting at any time will be assigned the highest mixing volume V at that time.

13. The method of claim 8, wherein selection of mixing templates and mixing of audio streams are correlated, and if a new mixing template is selected whereby a certain motion picture is enlarged, the audio mixing volume from that particular enlarged motion picture is simultaneously increased.

14. The method of claim 1, wherein making one or more motion pictures of the information subject related to information subjects are extracted from an initial motion picture

15. A system for synchronizing a first and a second motion picture, said first motion picture being provided by a first source and said second motion picture being provided by a second source, said system comprising:
a unit for receiving said motion pictures;
a unit for making a time line;
an arrangement for initiating said motion pictures;
an arrangement for providing motion pictures with unique codes based on said time line;
an arrangement for linking said motion pictures by relating said second motion picture to said first motion picture using said time line and the content of said first motion picture; and
an arrangement for generating a third motion picture comprising said synchronized and linked first and second motion pictures.

16. The system of claim 15, further comprising means for receiving several types of motion pictures.

17. The system of claim 15, wherein said first motion picture comprises video sequences of a person.

18. The system of claim 17, wherein said second motion picture comprises video sequences recorded from a computer application.

19. The system of claim 18, further comprising a server for storing said third motion picture.

20. The system of claim 19, wherein said server is connected to a network for access by means of a client computer.

21. An education system comprising: a system for allowing access of one or more pupils for running an education application according to claim 15 in which said first motion picture comprises a tutor video and said second motion picture an image of an application presented by said tutor.

22. A processor operable to carry out a computer program for performing a method of synchronizing a first and a second motion picture from a first and a second source in a digital environment, said method comprising:
initiating said motion pictures at a same start time on a time line;
providing sequences of said first motion picture with unique codes;
dividing said second motion picture into sections;
providing said sections with links and linking each of said sections with time codes of said sequences of said first motion picture; and
generating a third motion picture including said synchronized first and second motion pictures containing said links.

23. A propagated signal encoded with instructions for carrying out a method of synchronizing a first and a second motion picture from a first and a second source in a digital environment, said method comprising:
initiating said motion pictures at a same start time on a time line;
providing sequences of said first motion picture with unique codes;
dividing said second motion picture into sections;
providing said sections with links and linking each of said sections with time codes of said sequences of said first motion picture; and
generating a third motion picture comprising said synchronized first and second motion pictures containing said links.

24. A propagated signal encoded with a media stream that includes an information motion picture and an information subject motion picture which are produced according to a method of synchronizing a first and a second motion picture from a first and a second source in a digital environment, said method comprising:
initiating said motion pictures at a same start time on a time line;
arranging sequences of said first motion picture with unique codes;
dividing said second motion picture into sections;
providing said sections with links and linking each of said sections with time codes of said sequences of said first motion picture; and
generating a third motion picture comprising said synchronized first and second motion pictures containing said links.

25. A propagated signal encoded with a media stream that includes an information motion picture and an information subject motion picture which are produced in a system for synchronizing a first and a second motion picture, said first motion picture being provided by a first source and said second motion source being provided by a second source, said system comprising:
a unit for receiving said motion pictures;
a unit for making a time line;
an arrangement for initiating said motion pictures;
an arrangement for providing motion pictures with unique codes based on said time line;
an arrangement for linking said motion pictures by relating said second motion picture to said first motion picture using said time line and the content of said first motion picture; and
an arrangement for generating a third motion picture comprising said synchronized and linked first and second motion pictures.

26. A computer-readable medium encoded with a media stream that includes an information motion picture and an information subject motion picture which are produced according to a method of synchronizing a first and a second motion picture from a first and a second source in a digital environment, said method comprising:
initiating said motion pictures at a same start time on a time line;
arranging sequences of said first motion picture with unique codes;
dividing said second motion picture into sections;
providing said sections with links and linking each of said sections with time codes of said sequences of said first motion picture; and
generating a third motion picture comprising said synchronized first and second motion pictures containing said links.

27. A computer-readable medium encoded with a media stream that includes an information motion picture and an information subject motion picture which are produced by a system for synchronizing a first and a second motion picture, said first motion picture being provided by a first source and said second motion source being provided by a second source, said system comprising:
a unit for receiving said motion pictures;
a unit for making a time line;
an arrangement for initiating said motion pictures;
an arrangement for providing motion pictures with unique codes based on said time line; and
an arrangement for linking said motion pictures by relating said second motion picture to said first motion picture using said time line and the content of said first motion picture, and an arrangement for generating a third motion picture comprising said synchronized and linked first and second motion pictures.
